(19) United States
(12) Patent Application Publication
(10) Pub. No.: US 2014/0164174 A1
(43) Pub. Date: Jun. 12, 2014

(54) FAST-TRACK PAYMENTS

(71) Applicant: RAWLLIN INTERNATIONAL INC., Tortola (VG)

(72) Inventor: Vladimir V. Kitlyar, Sankt-Petersburg (RU)

(73) Assignee: RAWLLIN INTERNATIONAL INC., Tortola (VG)

(21) Appl. No.: 13/710,836

(22) Filed: Dec. 11, 2012

(51) Int. Cl. G06Q 30/06

(52) U.S. Cl. CPC G06Q 30/0633
USPC 705/26.8

(57) ABSTRACT

Systems and methods disclosed herein relate to fast-track payments at a retail store. Identification data can be received related to a user of a personal shopping device wherein the identifier includes payment preferences associated with the user. The personal shopping device can be personalized with the identification data. A shopping cart list can be dynamically received from the personal shopping device. A checkout request can be received from the personal shopping device. The checkout request can be processed based on the shopping cart list, using, at least in part, the payment preferences associated with the user. An area around the user at a security checkpoint can be scanned. An exit list can be identified based on the scanning. The exit list can be compared to the shopping cart list. Upon the list and the shopping cart list not matching, remedial action can be taken.

### TECHNICAL FIELD

This application relates to shopping and more particularly to a fast track payment system to securely checkout and exit a store without visiting a register.

### BACKGROUND

The brick and mortar shopping experience had remained unchanged for many years. Customers selected items they wished to purchase. Customers either gathered the items themselves, or gathered product identifiers that they could then take to a cashier to pay for. After paying for the products at the cashier, customers were free to leave the store with their products. One bottleneck in this traditional brick and mortar shopping experience is the check out process. Depending on the day of the week, the time of day, or the season, retail stores can vary in how busy they are. While appropriate staffing, e.g., additional cashiers available during busy times, can help alleviate the pressures that occur when a large amount of customers desire to check out in unison, additional cashiers cost money to employ, or are not always available.

A generally pleasant shopping experience for a customer while selecting products and adding them to their shopping cart can quickly change to a highly negative experience if the customer is forced to wait for an extended period of time to check out. Some customers may see long checkout lines and abandon the products they were planning on purchasing and leave the store without making a purchase. In the case of a customer that does wait in line for an extended period of time, they may not return to the store and may prefer to shop at a store carrying similar products but with less of wait, costing the original store potential future sales. In the case of a customer that abandons the cart, the store loses money in not conducting the sale, and may bear additional costs in restocking the items the customer abandoned to the proper place on their shelves.

With the advent of online shopping, consumers can choose to avoid the brick and mortar experience altogether and instead purchase a product online. In most cases, online customers do not have to wait in line to check out, and can purchase products on their own timeline. However, online shopping does carry inherent disadvantages. For example, a customer cannot physically see the product they are purchasing online and must rely on photos, videos, or a written description of the product. In addition, online shoppers most likely have to wait for the product to be packaged and shipped before receiving the product, while a brick and mortar shopper can take the product with them immediately.

While the traditional brick and mortar shopping experience has distinct advantages in seeing in the product, and catering to instant gratification in taking the product with you upon your exit of the store, processing brick and mortar transactions is traditionally far less convenient that processing an online transaction. Some stores have combated this problem by establishing self checkout lanes where customers can scan the products in their shopping cart, bag the products, and pay for the products. These self checkout lanes can be subject to the same inconveniences of the traditional cashier, in that lines can still form during busy shopping periods requiring customers to wait. For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to fast-track payments at a retail store. A communications component can send or receive data respectively to or from a personal shopping device. A payment information component can receive a payment profile from the personal shopping device, wherein the payment profile includes at least payment information representative of payment account information. A shopping cart component can receive a shopping cart list from the personal shopping device wherein the shopping cart list includes a list of products and associated product identifiers. A payment processing component can, in response to a checkout request received from the personal shopping device, process a transaction based on the payment information and the shopping cart list. A security checkpoint component can generate an exit list based on scanning a security checkpoint for product identifiers. A security action component can, at least one of verify the transaction, modify the transaction, or initiate an alarm based on comparing the exit list to the shopping cart list.

In another embodiment, identification data, including information representative of a user identity associated with a user of a personal shopping device can be received, wherein the identification data includes payment preference data associated with the user identity. Display data can be customized for a customized display on the personal shopping device based on the identification data. Shopping item data representing a set of items represented in shopping cart data from the personal shopping device can be received. In response to receiving a checkout request from the personal shopping device, the checkout request can be processed based on the shopping item data, using, at least in part, the payment preference data associated with the user identity. An area around the user associated with the user identity determined to be present at a security checkpoint of an egress can be scanned. Exit item data can be identified representing a set of potentially exiting items determined to be associated with the user identity based on the scanning. Exit item data can be compared to the shopping item data. In response to the comparing indicating a mismatch between the exit item data and the shopping item data, a defined remedial action can be initiated based on the mismatch.

In another embodiment, a personal shopping device can comprise a communications component that can send or receive data respectively to or from a secure shopping system. A personalization component that can receive identification data representing a user identity determined to be associated with a user of the personal shopping device, wherein the identification data includes payment preference data associated with the user identity. A scanning component can scan products, wherein in response to a product of the products being scanned, the product is added to a set of shopping cart items. A checkout component that, in response to receiving a checkout request, can send the set of shopping cart items to the secure shopping system. A payment processing component can, based on a response received from the secure shopping system, facilitate presentation of a transaction summary representing a transaction based on the shopping cart items and receives a transaction authorization authorizing the transaction based on the payment preference data.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates example flow diagram for implementing and using a fast-track system;

FIG. 2 illustrates an example secure shopping system;

FIG. 3 illustrates an example secure shopping system including an inventory component;

FIG. 4 illustrates an example flow diagram method for fast-track payment;

FIG. 5 illustrates an example flow diagram method for fast-track payment including verifying payment preferences;

FIG. 6 illustrates an example flow diagram method for fast-track payment including sending a receipt;

FIG. 7 illustrates an example flow diagram method for fast-track payment including depersonalizing the personal shopping device;

FIG. 8 illustrates an example personal shopping device;

FIG. 9 illustrates an example personal shopping device including a receipt component;

FIG. 10 illustrates an example personal shopping device including a depersonalization component;

FIG. 11 illustrates an example personal shopping device including a display component;

FIG. 12 illustrates an example block diagram of a computer operable to execute the disclosed architecture; and

FIG. 13 illustrates an example schematic block diagram for a computing environment in accordance with the subject specification.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Systems and methods disclosed herein relate to fast-track payments at a retail store. A customer can use their own smart phone, for example, or a proprietary store device to scan products as they are added to a shopping cart, and eventually pay for the same products. The customer can checkout using the device independent of the location of the device, therefore, avoiding any line in the checkout process. Products can be affiliated with a security mechanism, such as a magnetic tag or a radio tag, which can be scanned when the customer leaves the store. In this sense, the store can establish anti-theft protocols that unobtrusively protect a store's interest in theft prevention, while offering a heightened level of convenience to the customer.

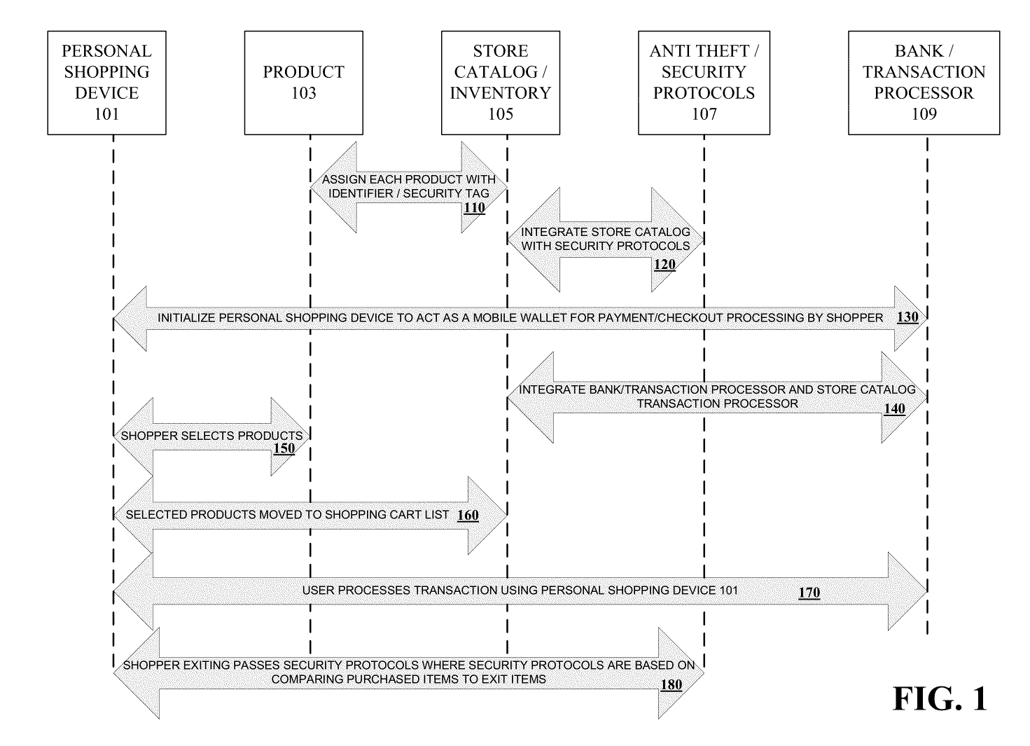

Referring now to FIG. 1 there is illustrated example flow diagram for implementing and using a fast-track system. The depicted steps illustrate exchanges of information that are both pre-requisite for implementing the fast-track system and well as steps in using the implemented fast track system. Steps 110 and 120 are perquisites for using the fast track system within a retail environment, as the products, store catalog, and security protocols are established to be later used by personal shopping device 101.

Personal shopping device 101 can be a proprietary device that includes the functionality as described herein or alternatively can be a consumer electronic device capable of communicating with the store. For example, a tablet or a smart phone with radio capabilities can communicate with the store, e.g., through an application, using a local wireless router, a wireless service provider, etc. In an example proprietary device system, a bin of proprietary devices can be placed near the entrance of the retail store, where a consumer grabs the proprietary device upon entrance to the retail store, and personalizes it as described in greater detail with regard to step 130 below.

At 110, each product 103 in a store catalog 105 can be assigned with a unique product identifier and/or security tag. For example, the assigning can be based off a uniform product code (“UPC”), a stock keeping unit (“SKU”), an attached short range radio frequency identification (“RFID”) tag, a long range RFID tag, or a magnetic tag. In one implementation, each individual product, including those products that are identical, can be outfitted with a unique identification such that store catalog 105 can uniquely identity individual variations of each product. In another implementation, the unique identifier can be shared by identical products. In another implementation, the unique identifier can be stationary near a product display, where the shopper can scan the unique identifier signaling a desire to purchase the product, but not actually physically taking the product or placing it in their cart. By establishing a store catalog/inventory 105 of products correlated with a unique identifier, the catalog can later be used by, for example, anti theft/security protocols 107 in securely processing the transaction. It can be appreciated that products can be assigned multiple identifiers. For example, the product can be assigned a UPC capable of being scanned at step 150 by personal shopping device 101, and also a magnetic tag capable of being scanned at a security gate by a security scanner.

At 120, store catalog/inventory 105 can be integrated with anti theft security protocols 107. For example, an anti-theft gate or area can be established at the exits of the store. At the gate, a scanner can be placed capable of reading the unique product identifiers described above. For example, if the unique identifier is a UPC, an image scanner or a video scanner can take photos or videos of products at a security checkpoint and determine the product identified by the scanner using the store catalog. In another example, an RFID scanner can read RFID tags, and then used the scanned information to identify the product the RFID tag is referencing. In another example, scanning the RFID tag returns the identity of the product as the identity is stored within the tag. It can be appreciated that many different types of scanning and identifier solutions are possible in implementing security protocols.

At 130, a consumer can begin the shopping process by initialize personal shopping device 101 to act as a mobile wallet for payment/checkout processing by the shopper. For example, using bank/transaction processor 109, the shopper can be identified, and in one example given a purchase limit. A customer could sign into personal shopping device 101 using a long, password, personal identification number (“PIN”), a thumb print, a fingerprint, facial recognition software, etc, where a shopper profile already exists with preferred payment instructions, such as a specific debit card, credit card, or checking account which the shopper wants to use to process the transaction. In another example, the personal shopping device 101 can have a card reader on the device that can scan a physical card such as a debit card or a credit card. Bank 109 can then authorize prospective charges to the card, by, for example, placing a hold of funds on the account until a transaction is completed or abandoned. In one example, the shopper can authorize personal shopping device 101 to place a specified amount on hold. It can be appreciated that a vendor can have some certainty that an amount placed on hold with credit or debit provider guarantees the funds are available later at checkout. A credit or charge limit can be established by the shopper, the bank or the retail store. Example of a credit or charge limit can include, a per transaction limit, a per day limit, a per week limit, a per month limit, etc. In addition, multiple shoppers can be affiliated with an identity, where limits are placed on individual shoppers or the group as a whole. For example, all members of a family can be affiliated with an account with common payment instructions; however, family members can have separate individual limits along with an overall family limit.

At 140, the bank/transaction processor 109 can be integrated with store catalog 105, such that the store catalog 105 can communicate transaction terms directly with bank/transaction processor and personal shopping device 101 can strictly communicate with the store. In this sense, access can be restricted to Bank/Transaction processor 109 to a single point of contact. It can be appreciated that in some instance, by limiting communications to a single point of contact, the security of transactions can be improved.

At 150, a shopper can begin selecting, e.g., scanning, products they wish to purchase. For example, customer could scan a SKU, a UPC, an RFID tag, a magnetic tag, etc. The identifier associated with the product can be stored on personal shopping device 101 for communication at step 160. It can be appreciated that communication at 160 can occur dynamically as products are scanned at 150. As products are scanned or selected at 150, they can be placed inside a cart, carried, etc. In an alternate implementation, a product display could be scanned signaling the shoppers intent to purchase the product, without placing the product in the cart or on their person. For example, large items like an appliance that are too heavy to lift or too large to fit in a cart can be scanned as an item the shopper intends to purchase, and as discussed in greater detail below, picked up by the shopper after checking out or alternatively the products can be shipped to the shopper. In some systems, such as those using RFID or magnetic tags, products can be concealed and still later detected at a security gate. It can be appreciated that those systems relying on photographic imagery or video imagery may not allow for concealing products after selection. In some implementations, as the product is selected, information about the product can be displayed on personal shopping device 101, such as pricing, subtotals, quantity, additional product information, a link to a manufacturer web site, a product set of frequently asked questions (“FAQs”), etc. In another implementation, products can be scanned or selected as items the shopper wishes to return to the shelf. For example, after a shopper has scanned an item, they may no longer wish to purchase the item. By scanning the item, the item can then be removed from a corresponding shopping cart list as described more fully below with regard to step 160.

At 160, products selected at 150 can be moved to a shopping cart list. The shopping cart list can aggregate the unique product identifiers associated with each product added to the list for later use at a security checkpoint when the shopper is exiting the store. In addition, as the shopping list is dynamically updated, the shopper can be informed via personal shopping device 101 of the subtotal of items in the cart, or whether a specific product is actually on the shopping cart list. For example, a child could add or remove items from the shopping cart without a guardian's knowledge, and the guardian may wish to consult the shopping cart list to determine if a product in the shopping cart is actually on the shopping cart list. In another implementation, items added to the shopping cart list can be collected at a different location, e.g., a warehouse. In another implementation, items added to the shopping cart list can be shipped after the transaction is completed. In a related application, systems and methods are disclosed for a smart shopping cart capable of identifying products within the cart.

At 170, the shopper using personal shopping device 101 can process the transaction, using just personal shopping device 101. For example, the payment terms authorized at step 130 can be used to complete the transaction by charging a debit card, credit card, withdrawing from a checking account, etc. The shopper using personal shopping device 101 is not required to meet with an automated or non-automated cashier to close the transaction. Thus, the shopper can be anywhere within the store to close the transaction. This can save the shopper a significant amount of time as items are not needed to be rescanned, subtotaled, and paid for under the traditional retail experience. At this stage, a receipt can be generated. The receipt can be printed on the personal shopping device, emailed to an email account associated with the shopper's identity, or saved and associated with the shopper's identity within the store. In implementations where the shopper is not collecting physical products, e.g., large appliances, heavy products, odd shaped products, etc., processing the transaction can initiate a process to have the purchased products available for pick up or shipped directly to the shopper.

At 180, a shopper exiting the store can pass through security protocols 107. The shopping cart, shopping bag, or the shopper themselves can be scanned to determine the products within the cart, bag, shopper. For example, security zones can be established at the store's exit where an image scanner, a video scanner, an RFID scanner, and/or a magnetic scanner, for example, can work individually or in tandem to determine an exit list. The exit list is a list of the actual products the shopper is leaving the store with. The shopping cart list which was subtotaled and paid for at step 170 can then be compared to the exit list. If the two lists don't match, many different solutions can be implemented. For example, if the shopping cart list, e.g., the list of items the shopper paid for, does not include items in the exit list, the shopper can be immediately billed for the unpaid for items. Shoppers can agree to have their method of payment charged for any items not previously paid for, and can be notified of the additional charges. In another example, an alarm can be triggered that notifies store personnel of a potential theft. In an example where the shopper paid for items that are not in the exit list, the transaction can be modified to provide a credit to the shopper. In an example where the shopper paid for items that are not in the exit list, but are products that must be either picked up at a separate location or later shipped to the shopper, modifying the transaction based on the exit list and the shopping cart list may be unnecessary.

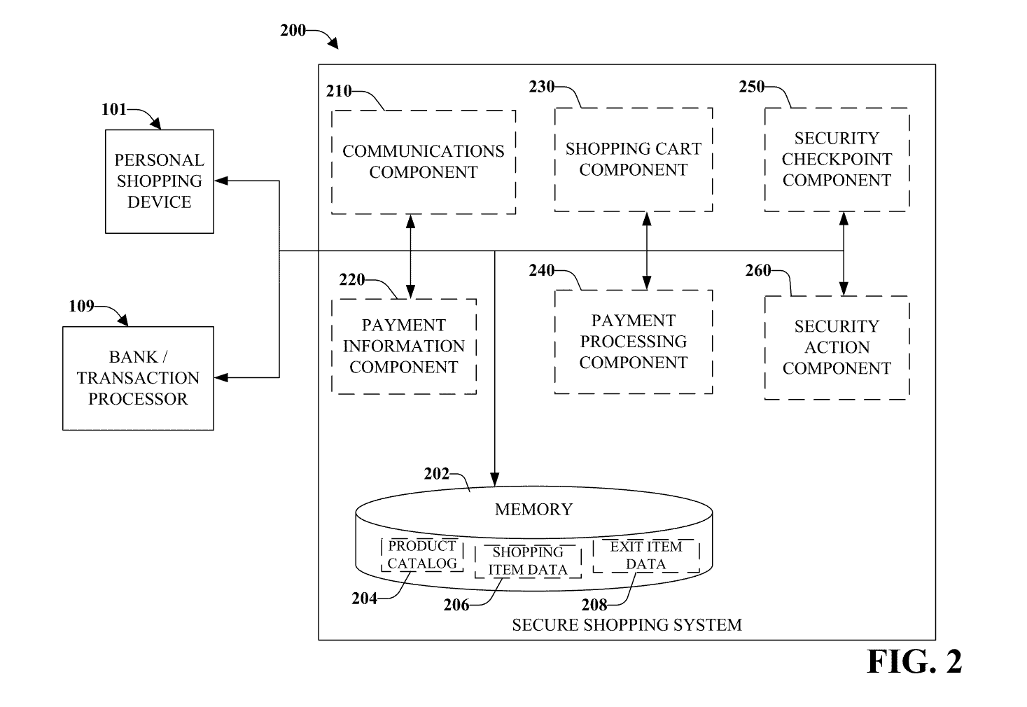

Referring now to FIG. 2 there is illustrated an example secure shopping system 200. Secure shopping system 200 can contain a communications component 210, a payment information component 220, a shopping cart component 230, a payment processing component 240, a security checkpoint component 250, a security action component 260, and a memory 202, that share a common bus. Memory 202 can house a product catalog 204, a shopping item data 206, and exit item data 208 for use by other components. Secure shopping system 200 can be in communication with personal shopping device 101 and bank/transaction processor 109. Communications component 210 can send or receive data respectively to or from personal shopping device 101 and bank/transaction processor 109.

Payment information component 220 can receive a payment profile from the personal shopping device, wherein the payment profile includes at least payment information representative of payment account information. In one implementation the payment information is representative of at least one of a debit card, a credit card, a routing number associated with a bank account, an account number associated with the bank account, or a store credit account. In one implementation, the payment information component 220 further receives contact information as a part of the payment profile. Contact information can include an email address, physical address, telephone number, etc.

Shopping cart component 230 can receive a shopping cart list from the personal shopping device wherein the shopping cart list includes a list of products and associated product identifiers. In one implementation, the product identifiers are at least one of a SKU, a UPC, a short range RFID tag, a long range RFID tag, or a magnetic tag.

Payment processing component 240 can, in response to a checkout request received from the personal shopping device, process a transaction based on the payment information and the shopping cart list. In one implementation, payment processing component 240 further sends a receipt associated with at least one of the transaction or the modified transaction to the contact information. In one implementation, payment processing component 240 can process the transaction independent of a location of the personal shopping device.

Security checkpoint component 250 can generate an exit list based on scanning a security checkpoint for product identifiers. In one implementation, the security checkpoint component 250 scans the security checkpoint for product identifiers using at least one of video scanning, image scanning, long range radio frequency identification (“RFID”) scanning, short range RFID scanning, or magnetic scanning. Security action component 260 can, at least one of, verify the transaction, modify the transaction, or initiate an alarm based on comparing the exit list to the shopping cart list.

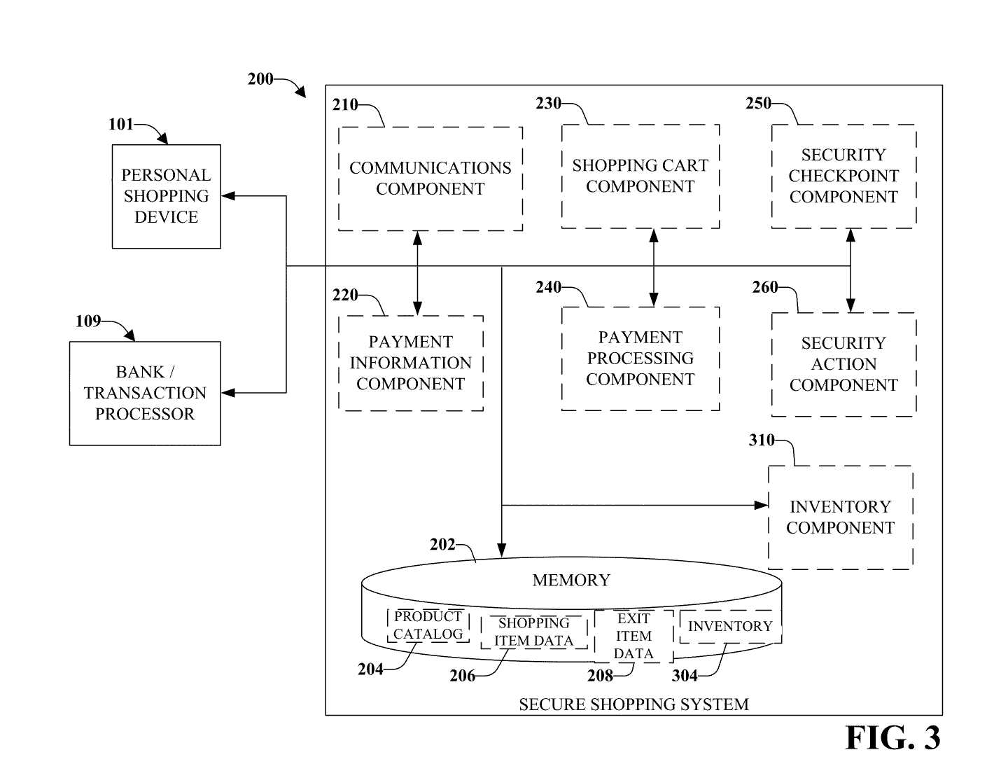

Referring now to FIG. 3 there is illustrated an example secure shopping system including an inventory component 310. Inventory component 310 can update a store inventory 304 based off at least one of the shopping cart list or the exit list. For example, as products are scanned and taken off the shelf and placed into a cart, inventory can be adjusted to reflect a reduced amount of product on the store shelves. Alarms or other indicators can then be established based off the dynamically changing inventory 304 such that purchased products can be replaced with fresh inventory. In another implementation, an order for additional inventory can be automatically placed with a supplier based on the inventory list 304 stored within memory 202.

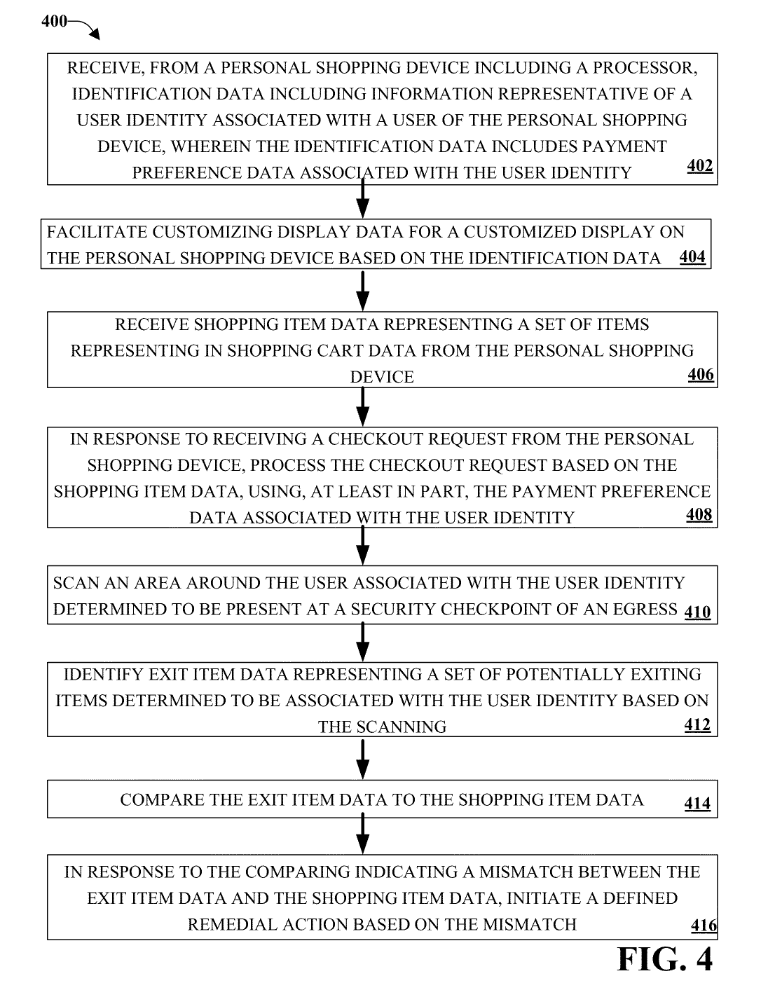

FIGS. 4-7 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 4 there is illustrated an example flow diagram method for fast-track payment. At 402, receive, from a personal shopping device including a processor, identification data including information representative of a user identity associated with a user of the personal shopping device, wherein the identification data includes payment preference data associated with the user identity. At 404, the method can facilitate customizing display data for a customized display on the personal shopping device based on the identification data. In one implementation, the identification data includes at least one of a thumbprint, a fingerprint, credit card information, debit card information, club card information, or a facial image. At 406, shopping item data representing a set of items represented in shopping cart data can be received from the personal shopping device.

At 408, in response to receiving a checkout request form the personal shopping device, the checkout request can be processed based on the shopping item data, using, at least in part, the payment preference data associated with the user identity. In one implementation, the processing the checkout request is independent of a location of the personal shopping device. At 410, an area around the user associated with the user identity determined to be present at a security checkpoint of an egress can be scanned. In one implementation, scanning the area around the user at the security checkpoint includes at least one of video scanning, image scanning, long range RFID scanning, short range RFID scanning, or magnetic scanning. At 412, the method can identify exit item data representing a set of potentially exiting items determined to be associated with the user identity based on the scanning. At 414, the exit item data can be compared to the shopping item data. At 416, in response to the comparing indicating a mismatch between the exit item data and the shopping item data, a defined remedial action can be initiated based on the mismatch. In one implementation, the initiating a defined remedial action includes at least one of triggering an alarm, processing a second checkout, processing a refund, or sending a message to the user identity.

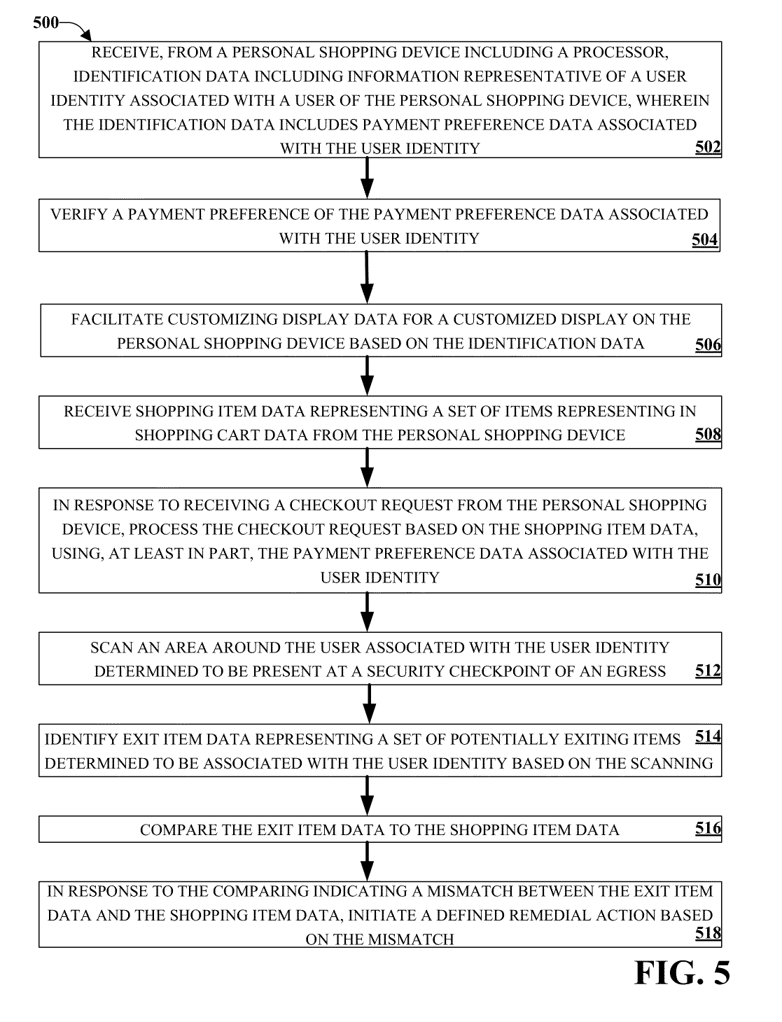

Referring now to FIG. 5 there is illustrated an example flow diagram method for fast-track payment including verifying payment preferences. At 502, receive, from a personal shopping device including a processor, identification data including information representative of a user identity associated with a user of the personal shopping device, wherein the identification data includes payment preference data associated with the user identity. At 504, a payment preference of the payment preference data associated with the user can be verified.

At 506, the method can facilitate customizing display data for a customized display on the personal shopping device based on the identification data. At 508, shopping item data representing a set of items represented in shopping cart data can be received from the personal shopping device. At 510, in response to receiving a checkout request form the personal shopping device, the checkout request can be processed based on the shopping item data, using, at least in part, the payment preference data associated with the user identity. At 512, an area around the user associated with the user identity determined to be present at a security checkpoint of an egress can be scanned. At 514, the method can identify exit item data representing a set of potentially exiting items determined to be associated with the user identity based on the scanning. At 516, the exit item data can be compared to the shopping item data. At 518, in response to the comparing indicating a mismatch between the exit item data and the shopping item data, a defined remedial action can be initiated based on the mismatch.

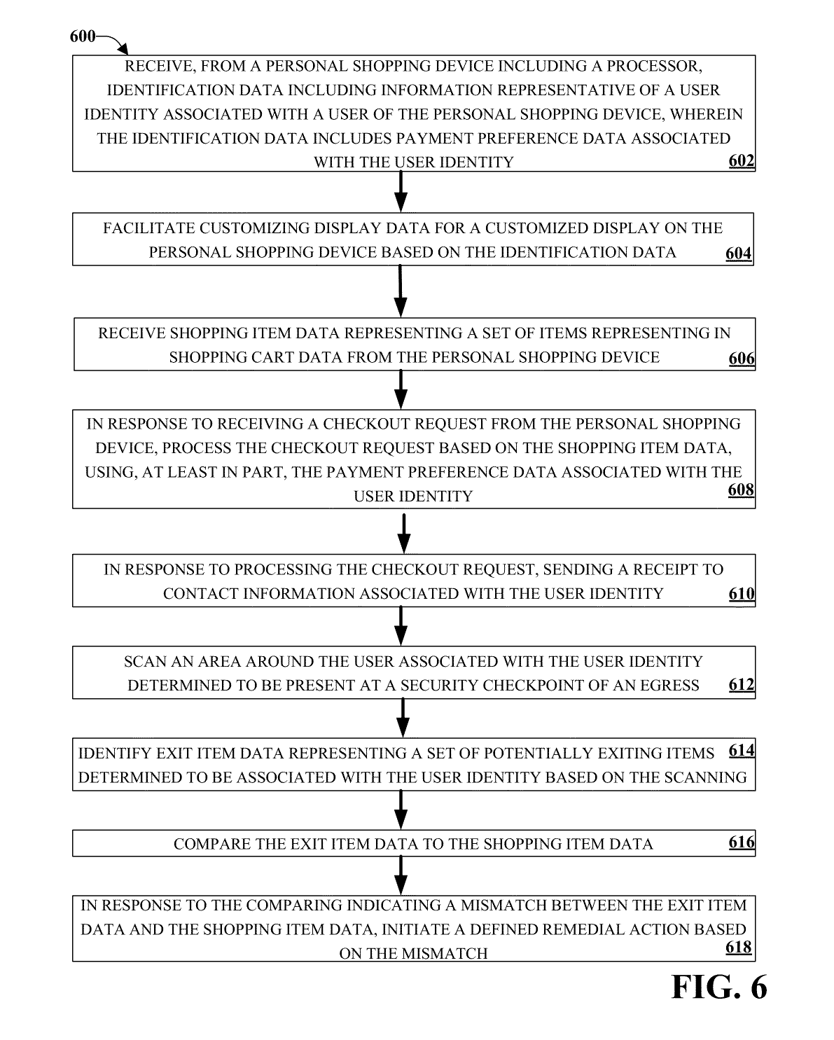

Referring now to FIG. 6 there is illustrated an example flow diagram method for fast-track payment including sending a receipt. At 602, receive, from a personal shopping device including a processor, identification data including information representative of a user identity associated with a user of the personal shopping device, wherein the identification data includes payment preference data associated with the user identity. At 604, the method can facilitate customizing display data for a customized display on the personal shopping device based on the identification data. At 606, shopping item data representing a set of items represented in shopping cart data can be received from the personal shopping device. At 608, in response to receiving a checkout request form the personal shopping device, the checkout request can be processed based on the shopping item data, using, at least in part, the payment preference data associated with the user identity.

At 610, in response to processing the checkout request, a receipt can be sent to contact information associated with the user identity. At 612, an area around the user associated with the user identity determined to be present at a security checkpoint of an egress can be scanned. At 614, the method can identify exit item data representing a set of potentially exiting items determined to be associated with the user identity based on the scanning. At 616, the exit item data can be compared to the shopping item data. At 618, in response to the comparing indicating a mismatch between the exit item data and the shopping item data, a defined remedial action can be initiated based on the mismatch.

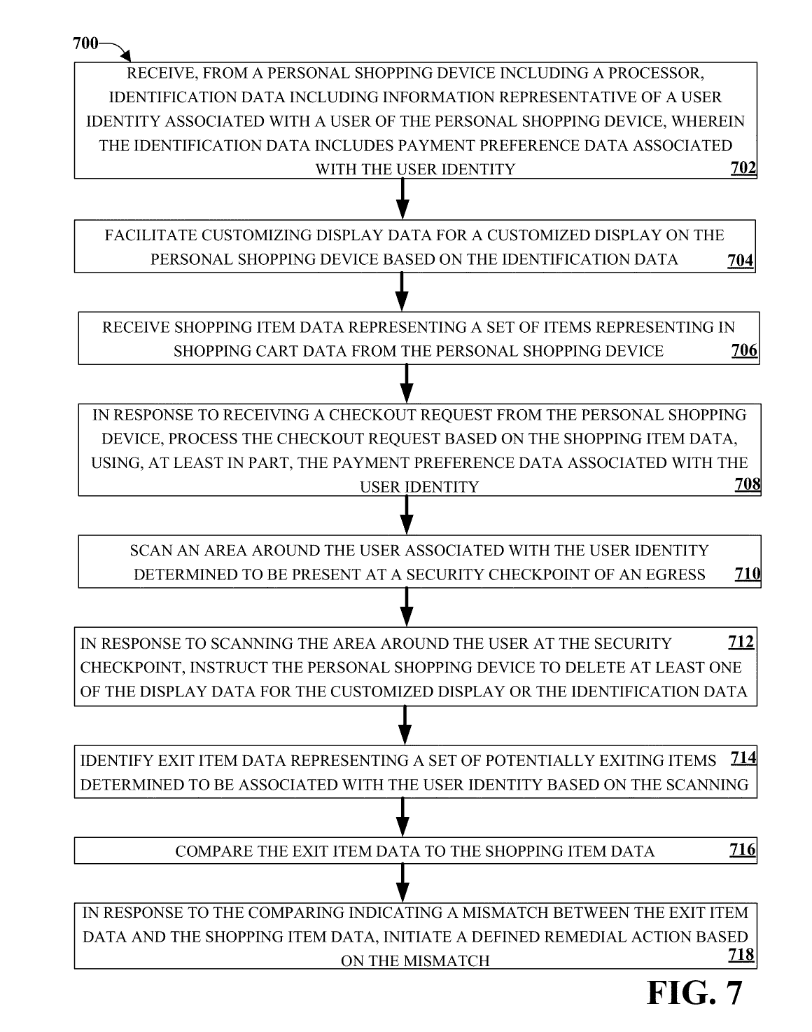

Referring now to FIG. 7 there is illustrated an example flow diagram method for fast-track payment including depersonalizing the personal shopping device. At 702, receive, from a personal shopping device including a processor, identification data including information representative of a user identity associated with a user of the personal shopping device, wherein the identification data includes payment preference data associated with the user identity. At 704, the method can facilitate customizing display data for a customized display on the personal shopping device based on the identification data. At 706, shopping item data representing a set of items represented in shopping cart data can be received from the personal shopping device. At 708, in response to receiving a checkout request form the personal shopping device, the checkout request can be processed based on the shopping item data, using, at least in part, the payment preference data associated with the user identity. At 710, an area around the user associated with the user identity determined to be present at a security checkpoint of an egress can be scanned.

At 712, in response to scanning the area around the user at the security checkpoint, the personal shopping device can be instructed to delete at least one of the display data for the customized display or the identification data. At 714, the method can identify exit item data representing a set of potentially exiting items determined to be associated with the user identity based on the scanning. At 716, the exit item data can be compared to the shopping item data. At 718, in response to the comparing indicating a mismatch between the exit item data and the shopping item data, a defined remedial action can be initiated based on the mismatch.

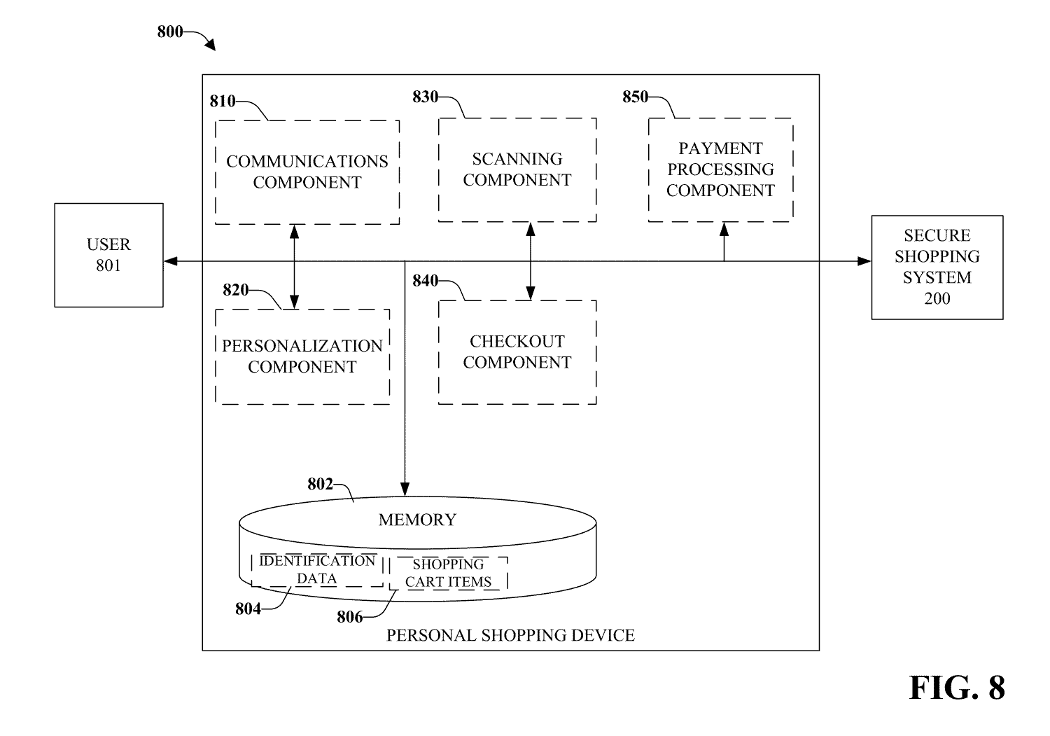

Referring now to FIG. 8, there is illustrated an example personal shopping device 800. Personal shopping device 800 has a communication component 810, a personalization component 820, a scanning component 830, a checkout component 840, a payment processing component 850, and a memory 802 capable of storing information that is accessible to components. Personal shopping device can be a smart phone, a tablet computer, a personal computer, a proprietary store device, etc. Personal shopping device 800 can receive inputs from user 801 and exchanges data with secure shopping system 200.

Communication component 810 can send and receive data respectively to or from a secure shopping system 200. Personalization component 820 can receive identification data 804 representing a user identity determined to be associated with a user 801 of the personal shopping device, wherein the identification data includes payment preference data associated with the user identity. Identification data 804 can be stored within memory 802, or stored within secure shopping system 200. In one implementation, the payment preference data associated with the identification data includes at least one of a debit card, a credit card, a routing number associated with a bank account, an account number associated with the bank account, or a store credit account.

Scanning component 830 can scan products, wherein in response to a product of the products being scanned, the product is added to a set of shopping cart items. Shopping cart items 806 can be stored within memory 802, or stored within secure shopping system 200. In one implementation, upon a product being scanned, the identification of the product is sent to secure shopping system 200. In one implementation, scanning component 830 receives quantity data representing a quantity of the product being scanned. In another implementation, scanning component 830 enables the product to be re-scanned to remove the product from the products and delete the product from the set of shopping cart items. In one implementation, scanning component 830 scans products by scanning at least one of a SKU, a UPC, a short range RFID tag, a long range RFID tag, or a magnetic tag.

Checkout component 840 can, in response to receiving a checkout request, send the set of shopping cart items to the secure shopping system. Payment processing component 850 can, based on a response received from the secure shopping system, facilitate presentation of a transaction summary representing a transaction based on the shopping cart items and receive a transaction authorization authorizing the transaction based on the payment preference data. In one implementation, payment processing component 850 can receive a transaction authorization independent of a location of the personal shopping device.

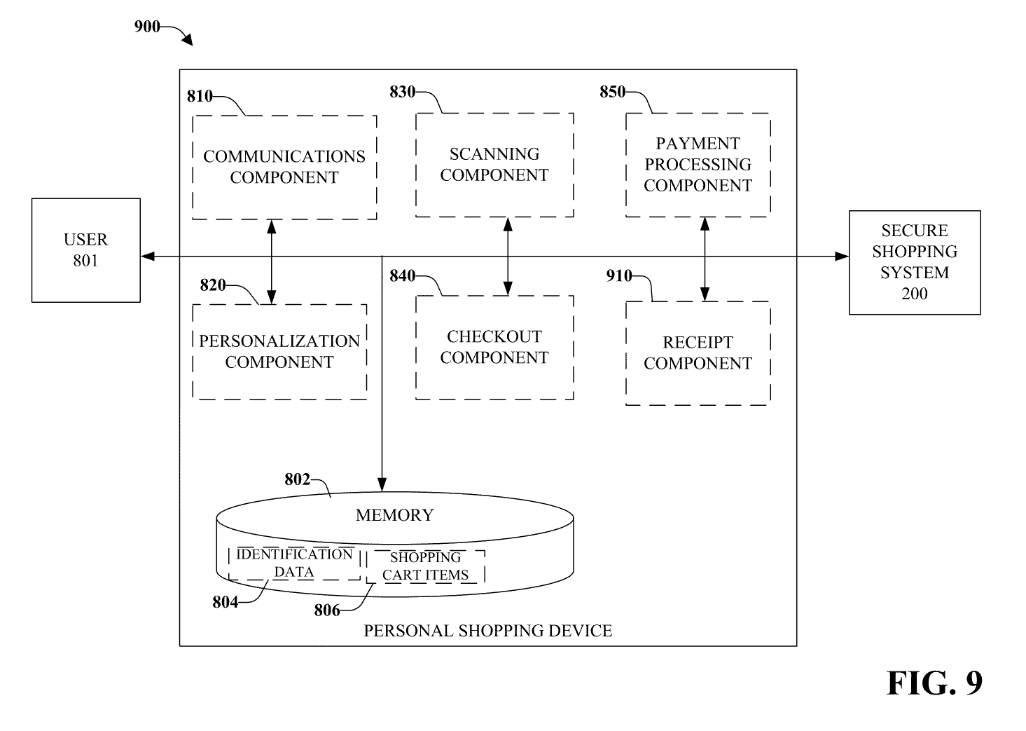

Referring now to FIG. 9, there is illustrated an example personal shopping device including a receipt component 910. Receipt component 910 can at least one of print a receipt or a send the receipt to an address associated with the user identity. For example, the email address can be a part of the identification data received by personalization component 820. It can be appreciated that in some implementations, personal shopping device 900 is not capable of printing a receipt.

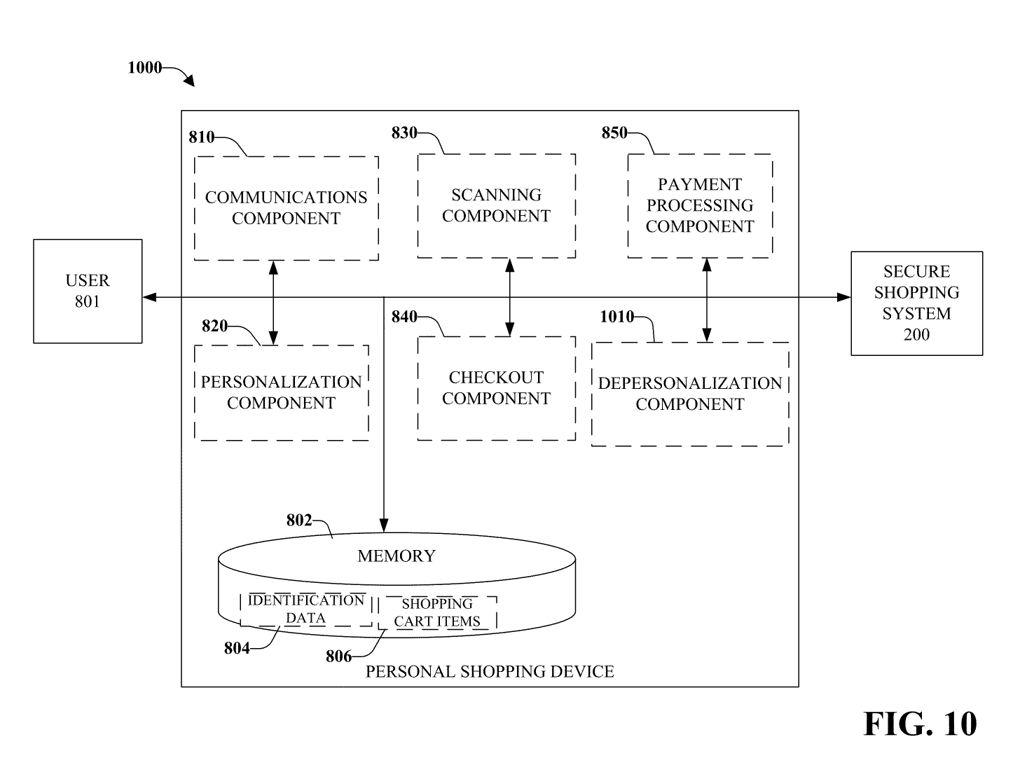

Referring now to FIG. 10, there is illustrated an example personal shopping device including a depersonalization component. Depersonalization component 1010 can, in response to a depersonalization triggering event, depersonalize the personal shopping device by removing at least one of the payment preference data or the identification data 804 from the memory 802. In one implementation, user 801 can be given the option of having the identification data removed from personal shopping device 1000. It can be appreciated that when using a proprietary store owned personal shopping device, best practice may be to depersonalize all devices after use for security reasons. Thus, in one implementation, a bin can be established whereby if a personal shopping device is placed in the associated bin, the device is automatically depersonalized. In another implementation where the personal shopping device is a user 801's smart phone, for example, they may wish to retain the identification data 804 within memory 802 for a future visit to the store.

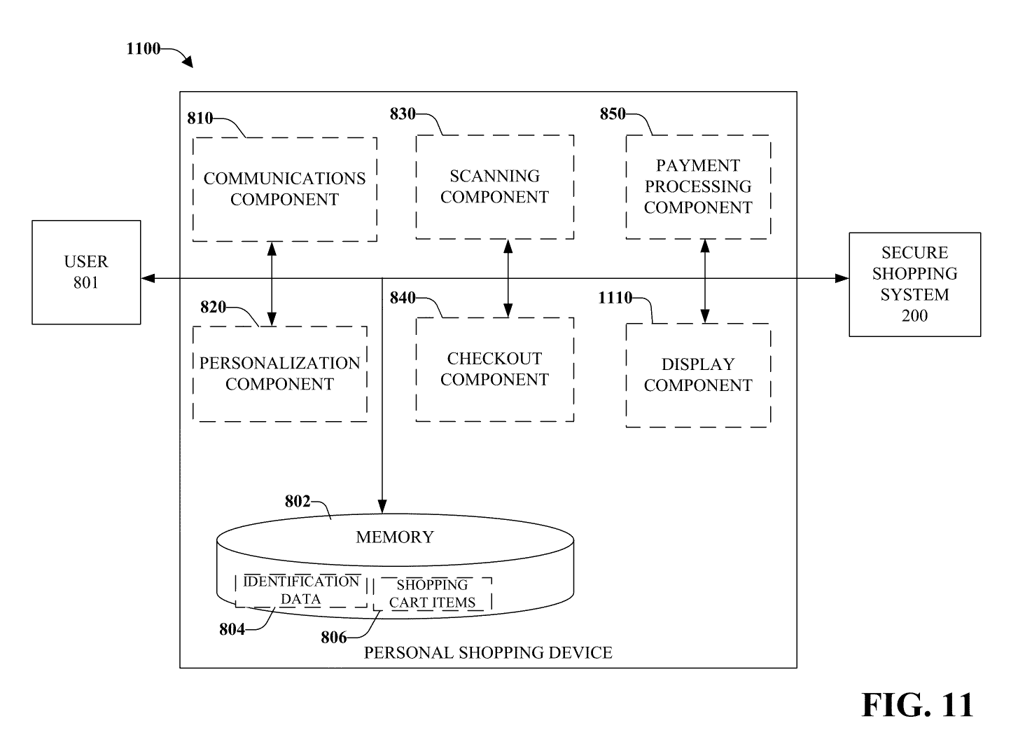

Referring now to FIG. 11, there is illustrated an example personal shopping device including a display component. Display component 1110 can display at least one of pricing information related to the product after the product has been scanned, the identification data, the set of shopping cart items, a pricing subtotal, or a product number subtotal. It can be appreciated that display component can give visual feedback to user 801 regarding the actions made by other components within system 1100.

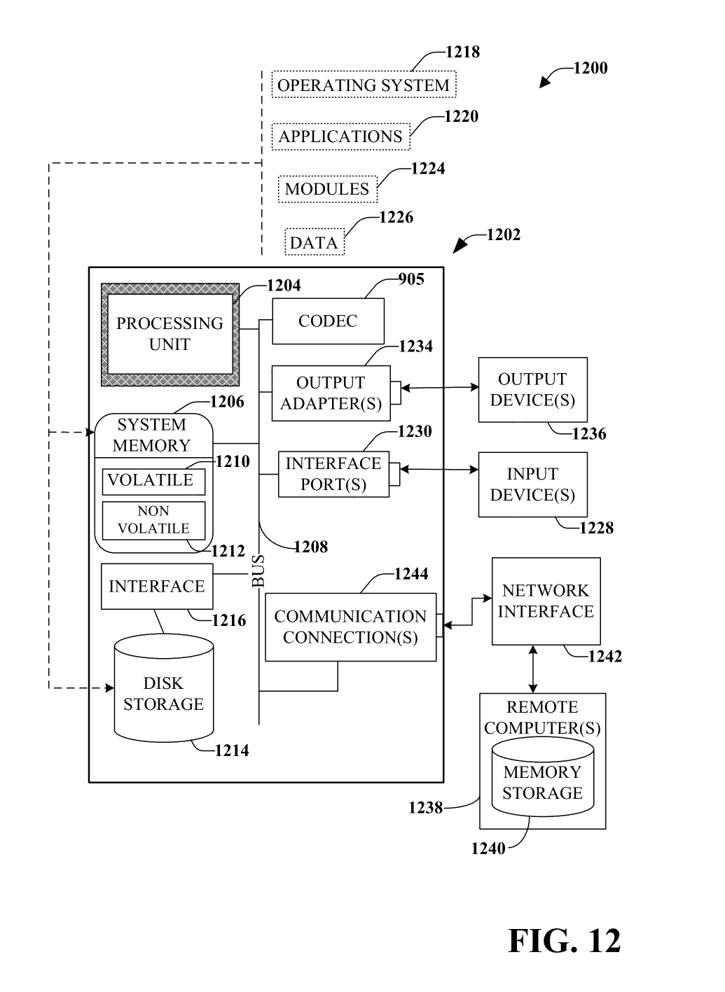

With reference to FIG. 12, a suitable environment 1200 for implementing various aspects of the claimed subject matter includes a computer 1202. The computer 1202 includes a processing unit 1204, a system memory 1206, a codec 1205, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic (not shown in FIG. 12) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1202 may also include removable/non-removable, volatile/non-volatile computer storage media. FIG. 12 illustrates, for example, a disk storage 1214. Disk storage 1214 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1214 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s) 1228. Thus, for example, a USB port may be used to provide input to computer 1202, and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

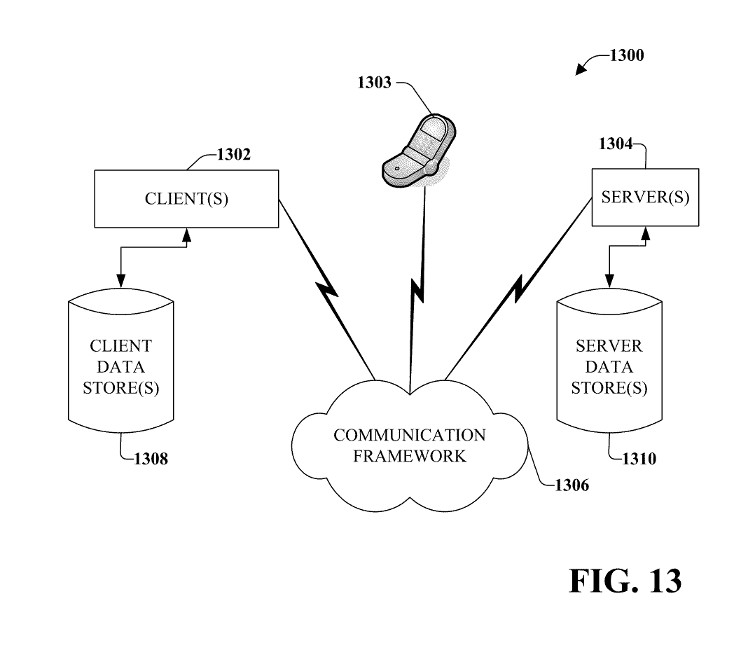

Referring now to FIG. 13, there is illustrated a schematic block diagram of a computing environment 1300 in accordance with the subject specification. The system 1300 includes one or more client(s) 1302, which can include an application or a system that accesses a service on the server 1304. The client(s) 1302 can be hardware and/or software (e.g., threads, processes, computing devices). The client(s) 1302 can house cookie(s) and/or associated contextual information by employing the specification, for example.

The system 1300 also includes one or more server(s) 1304. The server(s) 1304 can also be hardware or hardware in combination with software (e.g., threads, processes, computing devices). The servers 1304 can house threads to perform, for example, identifying morphological features, extracting meaning, auto generating FAQs, ranking, etc. One possible communication between a client 1302 and a server 1304 can be in the form of a data packet adapted to be transmitted between two or more computer processes where the data packet contains, for example, a certificate. The data packet can include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A method, comprising:
receiving, from a personal shopping device including a processor, identification data including information representative of a user identity associated with a user of the personal shopping device, wherein the identification data includes payment preference data associated with the user identity;
facilitating customizing display data for a customized display on the personal shopping device based on the identification data;
receiving shopping item data representing a set of items represented in shopping cart data from the personal shopping device;
in response to receiving a checkout request from the personal shopping device, processing the checkout request based on the shopping item data, using, at least in part, the payment preference data associated with the user identity;
scanning an area around the user associated with the user identity determined to be present at a security checkpoint of an egress;
identifying exit item data representing a set of potentially exiting items determined to be associated with the user identity based on the scanning;
comparing the exit item data to the shopping item data; and
in response to the comparing indicating a mismatch between the exit item data and the shopping item data, initiating a defined remedial action based on the mismatch.

2. The method of claim 1, wherein the processing the checkout request is independent of a location of the personal shopping device.

3. The method of claim 1, wherein the identification data includes at least one of a thumbprint, a fingerprint, credit card information, debit card information, club card information, or a facial image.

4. The method of claim 1, further comprising:
verifying a payment preference of the payment preference data associated with the user identity.

5. The method of claim 1, wherein the scanning the area around the user at the security checkpoint includes at least one of video scanning, image scanning, long range radio frequency identification (“RFID”) scanning, short range RFID scanning, or magnetic scanning.

6. The method of claim 1, further comprising:
in response to the processing the checkout request, sending a receipt to contact information associated with the user identity.

7. The method of claim 1, further comprising:
in response to the scanning the area around the user at the security checkpoint, instructing the personal shopping device to delete at least one of the display data for the customized display or the identification data.

8. The method of claim 1, wherein the initiating the defined remedial action includes at least one of triggering an alarm, processing a second checkout, processing a refund, or sending a message to the user identity.

9. A secure shopping system, comprising:
a memory to store computer executable components; and
a processor, communicatively coupled to the memory, that facilitates execution of the computer executable components, the computer executable components comprising:
a communications component that sends or receives data respectively to or from a personal shopping device;
a payment information component that receives a payment profile from the personal shopping device, wherein the payment profile includes at least payment information representative of payment account information;
a shopping cart component that receives a shopping cart list from the personal shopping device wherein the shopping cart list includes a list of products and associated product identifiers;
a payment processing component that in response to a checkout request received from the personal shopping device, processes a transaction based on the payment information and the shopping cart list;
a security checkpoint component that generates an exit list based on scanning a security checkpoint for product identifiers; and
a security action component that at least one of verifies the transaction, modifies the transaction, or initiates an alarm based on comparing the exit list to the shopping cart list.

10. The secure shopping system of claim 9, wherein the payment information is representative of at least one of a debit card, a credit card, a routing number associated with a bank account, an account number associated with the bank account, or a store credit account.

11. The secure shopping system of claim 9, wherein the payment information component further receives contact information as a part of the payment profile.

12. The secure shopping system of claim 11, wherein the payment processing component sends a receipt associated with at least one of the transaction or the modified transaction to the contact information.

13. The secure shopping system of claim 9, wherein the product identifiers include at least one of a stock keeping unit (“SKU”), a universal price code (UPC), a short range radio frequency identification (“RFID”) tag, a long range RFID tag, or a magnetic tag.

14. The secure shopping system of claim 9, wherein the security checkpoint component scans the security checkpoint for the product identifiers using at least one of video scanning, image scanning, long range radio frequency identification (“RFID”) scanning, short range RFID scanning, or magnetic scanning.

15. The secure shopping system of claim 9, wherein the payment processing component processes the transaction independent of a location of the personal shopping device.

16. The secure shopping system of claim 9, wherein the computer executable components further comprise:
an inventory component that updates a store inventory based on at least one of the shopping cart list or the exit list.

17. A personal shopping device, comprising:
at least one memory that stores computer executable components; and
a processor that facilitates execution of one or more computer executable components, the one or more computer executable components comprising:
a communications component that sends or receives data respectively to or from a secure shopping system;
a personalization component that receives identification data representing a user identity determined to be associated with a user of the personal shopping device, wherein the identification data includes payment preference data associated with the user identity.
a scanning component that scans products, wherein in response to a product of the products being scanned, the product is added to a set of shopping cart items;
a checkout component that, in response to receiving a checkout request, sends the set of shopping cart items to the secure shopping system; and
a payment processing component that, based on a response received from the secure shopping system, facilitates presentation of a transaction summary representing a transaction based on the shopping cart items and receives a transaction authorization authorizing the transaction based on the payment preference data.

18. The personal shopping device of claim 17, wherein the personal shopping device is at least one of a smart phone, or a tablet computer, or a transponder device.

19. The personal shopping device of claim 17, wherein the payment processing component receives the transaction authorization independent of a location of the personal shopping device.

20. The personal shopping device of claim 17, wherein the scanning component receives quantity data representing a quantity of the product being scanned.

21. The personal shopping device of claim 17, wherein the scanning component enables the product to be re-scanned to remove the product from the products and delete the product from the set of shopping cart items.

22. The personal shopping device of claim 17, wherein the scanning component scans products by scanning at least one of a stock keeping unit (“SKU”), a universal price code (UPC), a short range radio frequency identification (“RFID”) tag, a long range RFID tag, or a magnetic tag.

23. The personal shopping device of claim 17, further comprising:
a receipt component that at least one of prints a receipt or sends the receipt to an address associated with the user identity.

24. The personal shopping device of claim 17, further comprising:
a depersonalization component that, in response to a depersonalization triggering event, depersonalizes the personal shopping device by removing at least one of the payment preference data or the identification data from the memory.

25. The personal shopping device of claim 17, wherein the payment preference data associated with the identification data includes at least one of a debit card, a credit card, a routing number associated with a bank account, an account number associated with the bank account, or a store credit account.

26. The personal shopping device of claim 17, further comprising:
a display component that displays at least one of pricing information related to the product after the product has been scanned, the identification data, the set of shopping cart items, a pricing subtotal, or a product number subtotal.
